(19) United States
(12) Patent Application Publication
(10) Pub. No.: US 2023/0137968 A1
(43) Pub. Date: May 4, 2023

(54) 5G QoS Provisioning For An End-to-End Connection Including Non-5G Networks

(71) Applicant: QUALCOMM Incorporated, San Diego, CA (US)

(72) Inventors: Thomas STOCKHAMMER, Bergen (DE); Liangping MA, San Diego, CA (US); Nikolai Konrad LEUNG, San Francisco, CA (US); Imed BOUAZIZI, Frisco, TX (US)

(21) Appl. No.: 17/932,127

(22) Filed: Sep. 14, 2022

Related U.S. Application Data
(60) Provisional application No. 63/263,465, filed on Nov. 3, 2021.

(51) Int. Cl. H04L 47/10; H04L 47/24

(52) U.S. Cl. CPC H04L 47/18; H04L 47/24

(57) ABSTRACT

Various embodiments may include methods and systems for improving Quality of Service (QoS) in an end-to-end network connection including a first communication network and a second communication network. A method may include determining, by a network element within the end-to-end network connection, a QoS requirement of the end-to-end network connection, obtaining, by the network element, QoS information of the second communication network from a reporting entity within the second communication network, and adjusting, by the network element, a QoS parameter of the first communication network based on the determined QoS requirement and the obtained QoS information.

### RELATED APPLICATIONS

This application claims the benefit of priority to U.S. Provisional Patent Application No. 63/263,465 entitled “5G QoS Provisioning For An End-to-End Connection Including Non-5G Networks” filed Nov. 3, 2021, the entire contents of which are incorporated herein by reference for all purposes.

### BACKGROUND

A communication network may be configured to provide a Quality of Service (QoS) for an application, service, or data flow. There is a resource cost in provisioning a network to provide a certain QoS, so to meet a particular QoS requirement network, operators typically attempt to provide sufficient network resources without overcommitting or undercommitting network resources. Providing a QoS for an application, service, or data flow that involves communication across two or more networks of different types is even more complex.

### SUMMARY

Various aspects include systems and methods performed by a network element of a communication network for managing end-to-end Quality of Service (QoS) in an end-to-end network connection including a first communication network and a second communication network. Some aspects may include determining, by a network element within the end-to-end network connection, a QoS requirement of the end-to-end network connection, obtaining, by the network element, QoS information of the second communication network from a reporting entity within the second communication network, and adjusting, by the network element, a QoS parameter of the first communication network based on the determined QoS requirement and the obtained QoS information. In some aspects, the first communication network may be a 5G network and the second communication network is not a 5G network (i.e., the second communication network may be a non-5G network).

In some aspects, the reporting entity may be a device within the second communication network and the network element may be a device within the first communication network. Such aspects may further include measuring the QoS information by the reporting entity, obtaining, by the network element, QoS information of the second communication network from the reporting entity within the second communication network, and receiving the QoS information from the reporting entity by the network element.

In some aspects, the QoS information may include at least one of a round-trip delay of the end-to-end network connection, a one-way delay of the end-to-end network connection, or a packet error rate provided to the reporting entity. In some aspects, the QoS information may include a classification of the second communication network. In some aspects, the QoS information may include a request message indicating a requested change in a round-trip delay of the end-to-end network connection, a one-way delay of the end-to-end network connection, or a packet error rate provided to the reporting entity. In some aspects, the QoS information may include at least one of application information or traffic information.

In some aspects, obtaining, by the network element, QoS information of the second communication network from the reporting entity within the second communication network may include measuring a delay between the first communication network and an endpoint server within the second communication network.

In some aspects, the network element may be within the second communication network, and obtaining, by the network element, QoS information of the second communication network from the reporting entity within the second communication network may include measuring a delay between the reporting entity and the network element.

In some aspects, the network element may be within a third communication network that is communicably connected to the second communication network through the first communication network, and obtaining, by the network element, QoS information of the second communication network from the reporting entity within the second communication network may include measuring a delay between the reporting entity and the network element.

In some aspects, the network element may be within the first communication network, and obtaining, by the network element, QoS information of the second communication network from the reporting entity within the second communication network may include measuring a delay between the reporting entity and the network element.

In some aspects, determining, by the network element within the end-to-end network connection, the QoS requirement of the end-to-end network connection may include determining, by the network element, a QoS requirement of the end-to-end network connection based on a service agreement, application type, or user request, and adjusting, by the network element, the QoS parameter of the first communication network based on the determined QoS requirement and the obtained QoS information may include adjusting, by the network element, a 5G QoS parameter of the first communication network.

Further aspects include a network element having a processor configured to perform one or more operations of any of the methods summarized above. Further aspects include processing devices for use in a network element configured with processor-executable instructions to perform operations of any of the methods summarized above. Further aspects include a non-transitory processor-readable storage medium having stored thereon processor-executable instructions configured to cause a processor of a network element to perform operations of any of the methods summarized above. Further aspects include a network element having means for performing functions of any of the methods summarized above. Further aspects include a system on chip for use in a network element and that includes a processor configured to perform one or more operations of any of the methods summarized above.

### BRIEF DESCRIPTION OF THE DRAWINGS

FIG. 1A is a system block diagram illustrating an example communications system 100 suitable for implementing any of the various embodiments.

FIGS. 1B-1E are system block diagrams illustrating example communications systems suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a component block diagram illustrating a system configured for improving Quality of Service (QoS) in an end-to-end network connection including a first communication network and a second communication network in accordance with various embodiments

FIG. 5A is a component block diagram illustrating a relay system for improving QoS in an end-to-end network connection in accordance with various embodiments.

FIG. 5B is a message flow diagram illustrating call flows that may occur in the relay system architecture illustrated in FIG. 5A.

FIGS. 6A-6C are component block diagrams illustrating system architectures for improving QoS in an end-to-end network connection in accordance with various embodiments

FIG. 7A is a component block diagram illustrating a split-rendering system for improving QoS in an end-to-end network connection in accordance with various embodiments.

FIG. 7B is a message flow diagram illustrating call flows that may occur in the relay system architecture illustrated in FIG. 7A.

FIG. 8 is a process flow diagram illustrating an embodiment method for improving QoS in an end-to-end network connection including a first communication network and a second communication network according to various embodiments.

FIG. 9 is a process flow diagram illustrating an embodiment method for improving QoS in an end-to-end network connection including a first communication network and a second communication network that may be implemented as part of the method illustrated in FIG. 8 according to some embodiments.

FIG. 10 is a component block diagram of a network element device suitable for use with various embodiments.

FIG. 11 is a component block diagram of a wireless device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include systems and methods for improving Quality of Service (QoS) in an end-to-end network connection including a first communication network (e.g., 5G network) and a second communication network (e.g., non-5G network). A network element within a 5G network may be provisioned with a QoS requirement for an endpoint device, or endpoint user equipment (UE) withing a non-5G network connected to the 5G network. The network element may provide a QoS to the endpoint device based on the QoS requirement. However, the network element may not know, observe or otherwise be able to measure the actual conditions and statuses of the QoS provided to the endpoint device within the non-5G network. In various embodiments, the network element may obtain QoS information of the non-5G network from a reporting entity (e.g., AR glasses, head-mounted display (HMD), 5G phone) within the non-5G network. The network element may utilize the QoS information to adjust (i.e., if necessary to improve the QoS experienced by the endpoint UE, or to free up overprovisioned 5G network resources) a QoS parameter of the 5G network.

The term “network element” is used herein to refer to any one or all of a computing device that is part of or in communication with a communication network, such as a server, a router, a gateway, a hub device, a switch device, a bridge device, a repeater device, or another electronic device that includes a memory, communication components, and a programmable processor. A wireless device in communication with a network may be considered a network element of such network.

As used herein, the terms “network,” “communication network,” and “system” may interchangeably refer to a portion or all of a communications network or internetwork. A network may include a plurality of network elements. A network may include a wireless network, and/or may support one or more functions or services of a wireless network.

As used herein, “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

The term “wireless device” is used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard or in a single wireless device. The proximity of the SOCs facilitates high speed communications and the sharing of memory and resources.

The term “QoS information” may be used herein to refer to data or information related to Quality of Service (QoS) of an end-to-end connection. QoS information may be obtained by a network element for use in adjusting one or more QoS parameters (e.g., 5G QoS Identifier (5QI)) of a telecommunications network (e.g., 5G core network) based on a QoS requirement of an end-to-end network connection including the telecommunications network and other types of network connections (e.g., Bluetooth Low Energy (BLE), Wi-Fi, sidelink). QoS information may be reported to a network element from a device within an end-to-end network connection including the network element, or may be measured or otherwise determined by the network element. QoS information may include QoS-related information of non-5G networks (e.g., Wi-Fi, BLE, sidelink) including characteristics or metrics such as round-trip time or delay, one-way delay, or packet error rate. Packet error rate may also be referred to as packet loss rate. QoS information may further include a classification of a non-5G network that is part of an end-to-end connection. For example, a classification of a network connection may be a determination of whether a non-5G network is a Wi-Fi network (e.g., IEEE802.11ad, 802.11ac), BLE, or a wired connection (e.g., USB). As another example, a classification of a network may include a QoS configuration for a non-5G network, for example Wi-Fi, which may be defined by a particular access category (e.g., Best Effort or Video) under Enhanced Distributed Channel Access (EDCA). QoS information may further include desired changes to a QoS provided to a user equipment (UE) from a telecommunications network, in which the UE is within a different type of network of an end-to-end network connection including the telecommunications network. For example, a UE may report desired changes to a 5G network that provisions the UE with a certain level of QoS, and the desired changes may include a decrease in the amount of delay (e.g., round-trip delay, one-way delay) or packet error rate, and/or the amount of delay (e.g., round-trip delay, one-way delay) or packet error rate that is allowed to be increased without violating a Quality of Experience (QoE) of the UE. QoS information may further include measured metrics between a telecommunications network and an application, or endpoint, server, including one-way delay from the telecommunications network to the application server, one-way delay from the application server to the telecommunications network, and/or round-trip delay between the telecommunications network and the application server. QoS information may further include information about an application being run on a UE, such as the video codec, audio codec, bit rates, frame rate, latency (e.g., for doing rendering, for detecting a pose change), QoS requirements (e.g., on throughput and/or latency). QoS information may further include information about network traffic, such as whether the traffic is symmetric between uplink and downlink, whether the uplink traffic is mainly light commands and pose but delay stringent, and whether the downlink traffic is mainly heavy multimedia content but with a less stringent delay requirement. QoS information may further include a time delay between a remote, or an endpoint, UE and a device hosting a renderer function for purposes or augmented reality (AR) or mixed reality (MR) applications.

Providing a QoS for an application, service, or data flow that involves communication across two or more networks of different types is complex. A communication network may be able to determine information about, and configure the operations of, its own network elements, including devices communicating with or to those network elements (e.g., devices connected to the communication network). However, a communication network may be unable to obtain information about the operations of other communication networks. For example, an application client of a wireless device may communicate over a communication path with another device (e.g., an application server, or another wireless device). The communication path between the two endpoint devices (the “end-to-end” communication path) may span multiple networks.

As an example, to provide augmented reality application, wireless smart glasses may communicate with (i.e., send signals to and receive signals from) an application server over a communication path that spans multiple communication networks. For instance, the smart glasses may communicate with a smart phone over a Wi-Fi network; the smart phone may communicate with a 5G network base station over a cellular communication link; the 5G network may communicate with an internetwork (e.g., the internet); and the internetwork may communicate with a wired network using Ethernet that includes the application server. In this example, the communication path between the smart glasses and the application server spans a Wi-Fi network, a 5G network, an internetwork, and a wired Ethernet network. The augmented reality application of the smart glasses may require a particular QoS to meet one or more application requirements. One network, e.g., the 5G network, may be able to configure its various network elements according to the QoS requirement of the application. However, the 5G network typically has no control over the configuration or operations of network elements of non-5G networks, such as the Wi-Fi network, the internetwork, or the wired Ethernet network. QoS of the non-5G networks may be improved by allocating more resources to a 5G network connection to and endpoint device, but overprovisioning 5G core network resources is costly and inefficient.

Various embodiments include methods and network devices configured to perform the methods of improving QoS in an end-to-end network connection including a first communication network (e.g., 5G network) and a second communication network (e.g., non-5G network), among other types of communication networks. In various embodiments, by a network element within the end-to-end network connection may determine a QoS requirement of the end-to-end network connection, typically provided by the endpoint device within the second communication network. For example, an application, service, or data flow may request, or may be associated with, a QoS requirement. The network element of the first communication network may obtain QoS information of the second communication network from a reporting entity (e.g., endpoint UE, intermediary UE such as a 5G phone, endpoint server) within the second communication network. The network element, based on the determined QoS requirement and the obtained QoS information, may then adjust a QoS parameter of the first communication network to provide sufficient QoS to support the end-to-end connection including the second communication network.

In some embodiments, a network element within an end-to-end network connection may determine a QoS requirement of the end-to-end network connection. The QoS requirement of an end-to-end network connection may be based in part on the QoS requirement (e.g., bandwidth, bit rate, packet error rate, etc.), or data needs, of a UE. When establishing a connection between a UE located within a non-5G network of the end-to-end network connection and a telecommunications network such as a 5G core network, the UE may provide a network element within the telecommunications network with a QoS requirement outlining the basic data needs of the UE. For example, the UE may inform the network element that the UE implements streaming video applications, and the network element may configure the telecommunications network to provide a QoS that is common among streaming video services. In some embodiments, the network element may detect a device or application type of the UE and may configure the 5G network. The network element may configure the 5G network based on the QoS requirement of the UE, therefore providing a generalized QoS to the endpoint UE. However, outside of the 5G network within a non-5G network in which the endpoint UE is located, the actual endpoint QoS may be unknown to the 5G network. The 5G network may have no visibility of and no direct control over the non-5G networks, and therefore may not be able to optimize the QoS provided to the endpoint UE via the 5G network. For example, the 5G network, as configured by the network element, may overprovision QoS to the UE based solely on a QoS requirement received from a UE, such that the UE is provided with an excess of resources (e.g., too much bandwidth, bit rate; low packet rate, etc.), therefore wasting 5G network resources. As another example, the 5G network, as configured by the network element, may not provision the UE with sufficient QoS. In this case, the QoE of a user of the endpoint UE may be poor, but the network element of the 5G network would be unaware of the poor QoS experienced within the non-5G network.

Various embodiments allow for a network element of a 5G network to manage the speed and quality of an end-to-end network connection in which the end-to-end QoE is not exclusively impacted by the 5G QoS but also impacted by the QoS of non-5G networks.

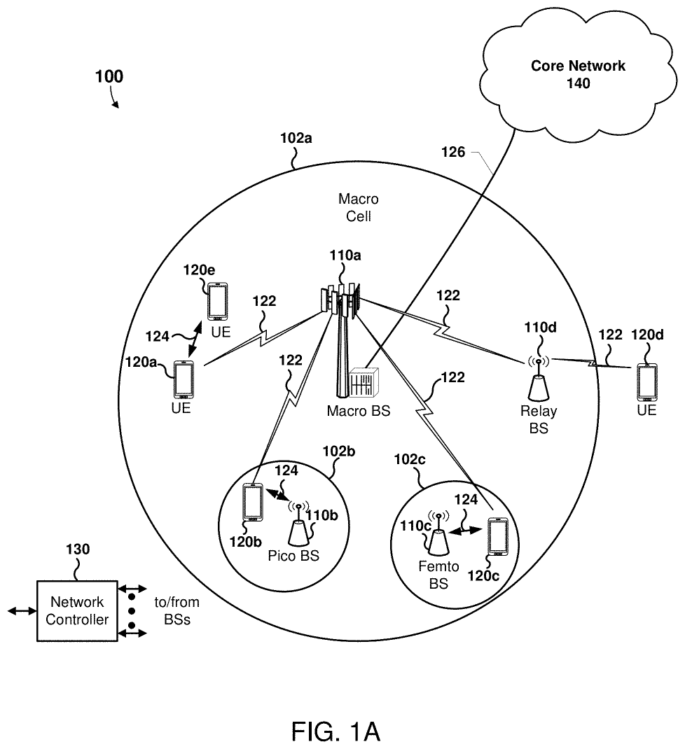

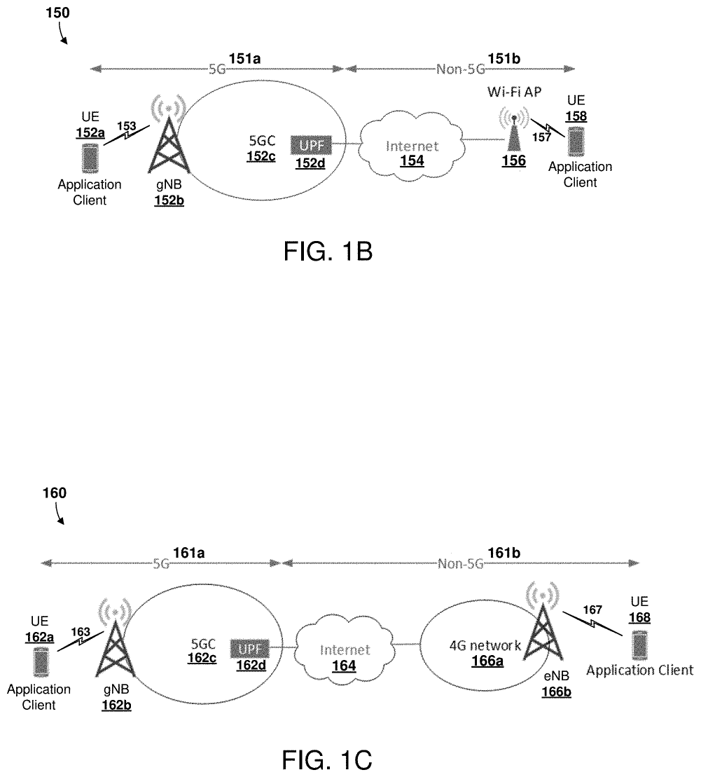

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as user equipment (UE) 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In third generation partnership project (3GPP), the term “cell” can refer to a coverage area of a base station, a base station subsystem serving this coverage area, or a combination thereof, depending on the context in which the term is used. The core network 140 may be any type core network, such as an LTE core network (e.g., an EPC network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more wireless devices 120a-120e (for example, illustrated as the wireless device 120a and the wireless device 120e) may communicate directly using one or more sidelink channels 124 (for example, without using a base station 110a-110d as an intermediary to communicate with one another). For example, the wireless devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

FIGS. 1B-1D are system block diagrams illustrating example communications systems 150, 160, 170, and 180 suitable for implementing any of the various embodiments. With reference to FIGS. 1A-1D, the communications systems 150, 160, 170, and 180 illustrate examples end-to-end communication paths between two endpoint devices that span multiple communication networks. It will be understood that the examples illustrated in communications systems 150, 160, 170, and 180 are non-limiting, and that other implementations of end-to-end communication paths between two endpoint devices that span multiple communication networks are also possible.

Referring to FIG. 1B, an application client executing on a UE 152a (e.g., the wireless devices 120a-120e) may communicate with an application client executing on a UE 158 (e.g., the wireless devices 120a-120e). The communication path between the UE 152a and the UE 158 may span two networks, for example, a 5G network 151a and a non-5G network 151b. In some embodiments, the 5G network 151a may include the UE 152a that may communicate with a gNB 152b via a cellular communication link 153, a 5G core network 152c, and a user plane function 152d that may enable communication between the 5G network 151a and the non-5G network 151b. The non-5G network 151b may include an internetwork such as the internet 154, a Wi-Fi access point 156, and the wireless device 158, which may communicate with the Wi-Fi access point 156 via a Wi-Fi wireless communication link 157.

Referring to FIG. 1C, an application client executing on a UE 162a (e.g., the wireless devices 120a-120e) may communicate with an application client executing on a UE 168 (e.g., the wireless devices 120a-120e). The communication path between the UE 162a and the UE 168 may span two networks, for example, a 5G network 161a and a non-5G network 161. In some embodiments, the 5G network 161a may include the UE 162a that may communicate with a gNB 152b via a cellular communication link 163, a 5G core network 162c, and a user plane function 162d that may enable communication between the 5G network 161a and the non-5G network 161b. The non-5G network 161b may include an internetwork such as the internet 164, a 4G network 166a, a 4G base station such as an eNB 166b, and a wireless device 168, which may communicate with the eNB 166b via a 4G wireless communication link 167.

Referring to FIG. 1D, the communication system 170 may include three networks. An application client executing on a wireless device 174 (illustrated as smart glasses) in a first non-5G network 171b may communicate with an application server 176 in a second non-5G network 171c via a 5G network 171a. In this manner, the communication path between the wireless device 174 and the application server 176 may span three communication networks. In some embodiments, the first non-5G network 171b may include the wireless device 174, which may communicate with a wireless device (UE) 172a via a Wi-Fi communication link 173. The 5G network 171a may include the UE 172a that may communicate with a gNB 172b via a cellular communication link 175, a 5G core network 172c, and a user plane function 172d that may enable communication between the 5G network 171a and the second non-5G network 171c. The second non-5G network 171c may include the application server 176, which may communicate with the 5G network via a wired communication link 177.

Referring to FIG. 1E, the communication system 180 may include three networks. An application client executing on a wireless device 184 (illustrated as smart glasses) in a first non-5G network 181b may communicate with an application server 188 in a second non-5G network 181c via a 5G network 181a. In this manner, the communication path between the wireless device 184 and the application server 188 may span three communication networks. In some embodiments, the first non-5G network 181b may include the wireless device 184, which may communicate with a wireless device (UE) 182a via a Wi-Fi communication link 181. The 5G network 181a may include the UE 182a that may communicate with a gNB 182b via a cellular communication link 185, a 5G core network 182c, and a user plane function 182d that may enable communication between the 5G network 181a and the second non-5G network 181c. The second non-5G network 181c may include an internetwork (such as the internet) 186 that may communicate with the 5G network via a cellular communication link 185, and the application server 188, which may communicate with the internetwork 186 via a wired communication link 187.

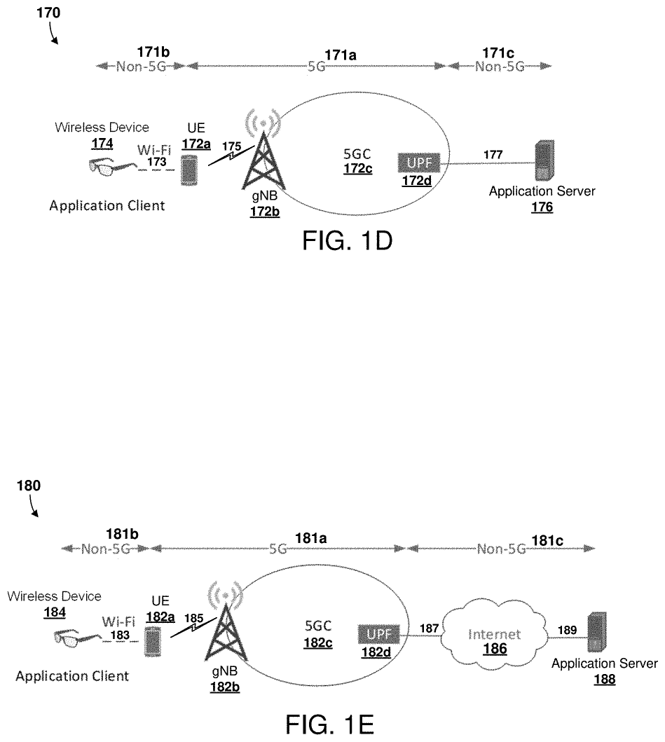

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1 and 2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a wireless device (e.g., 120a-120e) or a base station (e.g., 110a-110d). In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

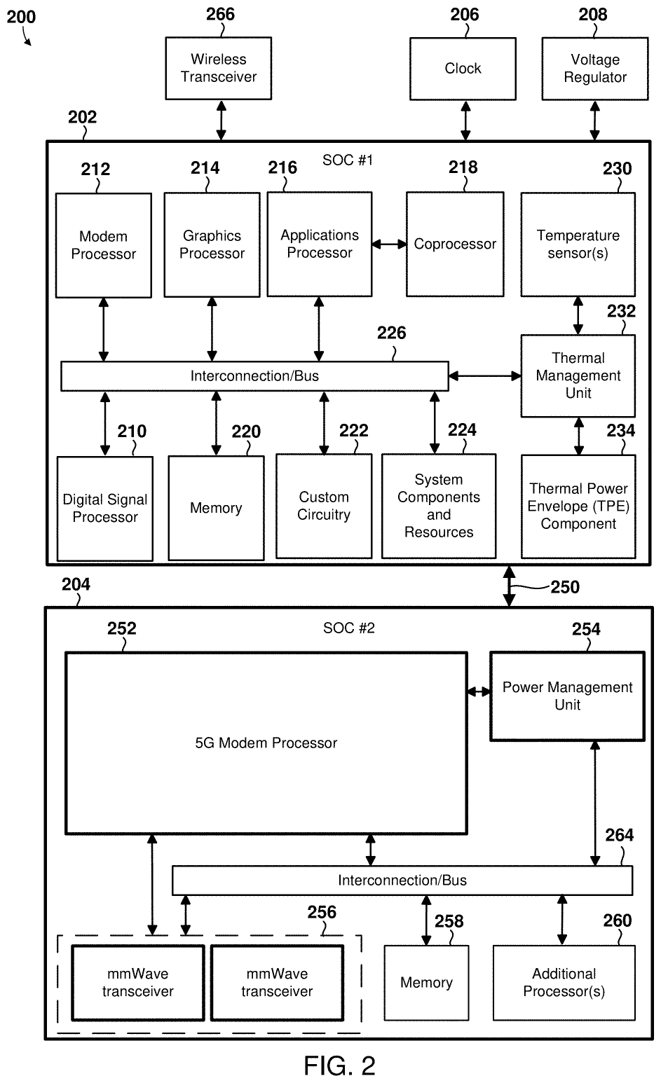

FIG. 3 is a component block diagram illustrating a software architecture 300 including a radio protocol stack for the user and control planes in wireless communications suitable for implementing any of the various embodiments. With reference to FIGS. 1-3, the wireless device 320 may implement the software architecture 300 to facilitate communication between a wireless device 320 (e.g., the wireless device 120a-120e, 200) and the base station 350 (e.g., the base station 110a-110d) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the wireless device 320 and the base station 350.

In various embodiments, the SDAP sublayer 317 may provide mapping between Quality of Service (QoS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

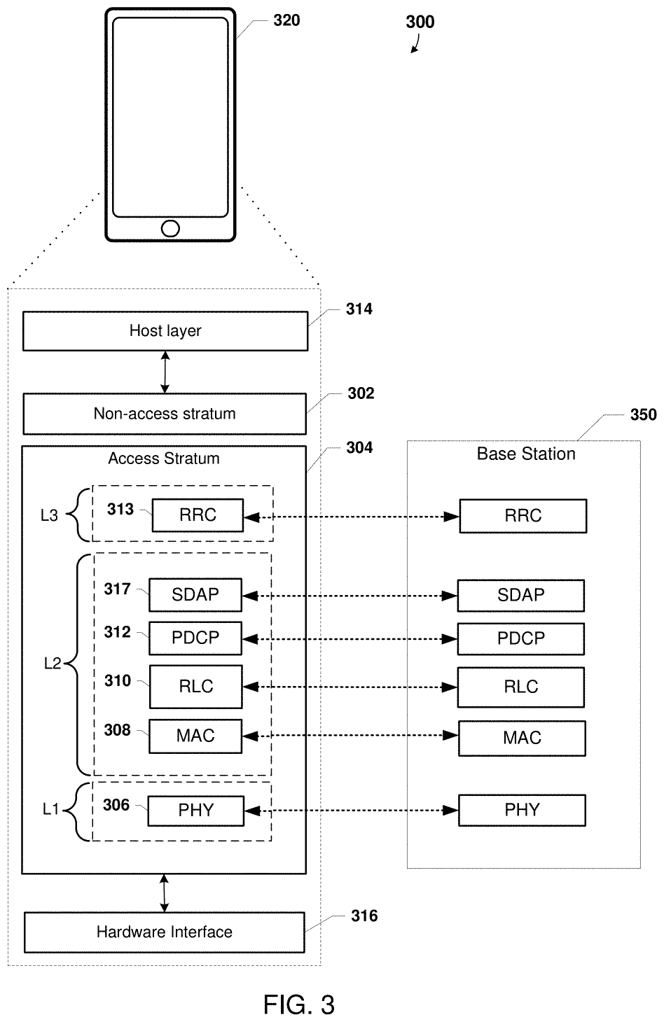

FIG. 4 is a component block diagram illustrating a system 400 configured for improving QoS in an end-to-end network connection including a first communication network and a second communication network in accordance with various embodiments. With reference to FIGS. 1-4, system 400 may include a network element 402 of a 5G network, such as a wireless device (e.g., 110a-110d, 200, 320), a base station (e.g., 120a-120e, 200, 350), or another network element of a 5G network, including any network element of the core network 140 or the 5G networks 151a, 161a, 171a, and 181a.

The network element 402 may include one or more processors 428 coupled to electronic storage 426 and a transceiver 427 (which may be a wired transceiver and/or a wireless transceiver, e.g., 266). In the network element 402, the transceiver 427 may be configured to receive messages sent in transmissions and pass such message to the processor(s)428 for processing. Similarly, the processor 428 may be configured to send messages for transmission to the transceiver 427 for transmission. The network element 402 may send or receive messages to or from a communication network 424 via a wired and/or wireless communication link.

Referring to the network element 402, the processor(s) 428 may be configured by machine-readable instructions 406. Machine-readable instructions 406 may include one or more instruction modules. The instruction modules may include computer program modules. The instruction modules may include one or more of an end-to-end QoS module 408, a QoS obtaining module 410, a QoS adjustment module 412, or other instruction modules.

The end-to-end QoS module 408 may be configured to determine a QoS requirement of an end-to-end network connection for communicating packets from a packet source (e.g., endpoint UE) to a packet destination (e.g., endpoint server), and vice versa. The end-to-end QoS module may be configured to determine a QoS requirement of the end-to-end network connection based on a service agreement, application type, or user request.

The QoS obtaining module 410 may be configured to obtain QoS information of the second communication network from a reporting entity (e.g., endpoint UE, intermediary UE, endpoint server) within the second communication network. The QoS obtaining module 410 may be configured to receive the QoS information from the reporting entity by the network element. The QoS obtaining module 410 may be configured to measure a delay between the first communication network and an endpoint server within the second communication network. The QoS obtaining module 410 may be configured to measure a delay between the reporting entity and the network element.

The QoS adjustment module 412 may be configured to adjust a QoS parameter of the first communication network based on the determined QoS requirement and the obtained QoS information. The QoS adjustment module 412 may be configured to adjust a 5G QoS parameter of the first communication network.

The electronic storage 426 may include non-transitory storage media that electronically stores information. The electronic storage media of electronic storage 426 may include one or both of system storage that is provided integrally (i.e., substantially non-removable) with the network element 402 and/or removable storage that is removably connectable to the network element 402 via, for example, a port (e.g., a universal serial bus (USB) port, a firewire port, etc.) or a drive (e.g., a disk drive, etc.). Electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426 may include one or more virtual storage resources (e.g., cloud storage, a virtual private network, and/or other virtual storage resources). Electronic storage 426 may store software algorithms, information determined by processor(s) 428, information received from the network element 402, or other information that enables the network element 402 to function as described herein.

Processor(s) 428 may be configured to provide information processing capabilities in the network element 402. As such, the processor(s) 428 may include one or more of a digital processor, an analog processor, a digital circuit designed to process information, an analog circuit designed to process information, a state machine, and/or other mechanisms for electronically processing information. Although the processor(s) 428 are illustrated as single entities, this is for illustrative purposes only. In some embodiments, the processor(s) 428 may include a plurality of processing units and/or processor cores. The processing units may be physically located within the same device, or processor(s) 428 may represent processing functionality of a plurality of devices operating in coordination. The processor(s) 428 may be configured to execute modules 408-412 and/or other modules by software; hardware; firmware; some combination of software, hardware, and/or firmware; and/or other mechanisms for configuring processing capabilities on processor(s) 428. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 408-412 described below is for illustrative purposes, and is not intended to be limiting, as any of modules 408-412 may provide more or less functionality than is described. For example, one or more of the modules 408-412 may be eliminated, and some or all of its functionality may be provided by other modules 408-412. As another example, the processor(s) 428 may be configured to execute one or more additional modules that may perform some or all of the functionality attributed below to one of the modules 408-412.

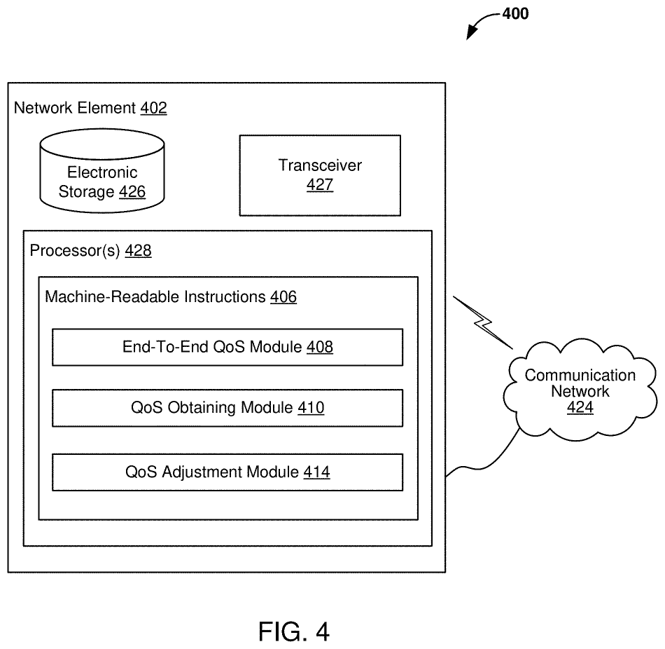

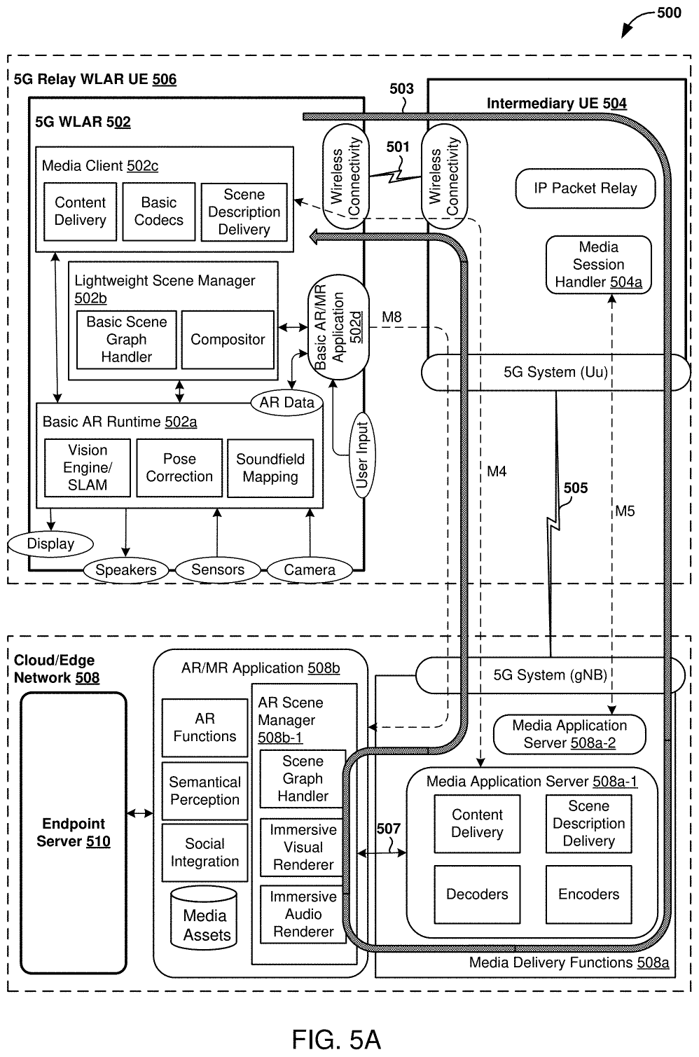

FIG. 5A is a component block diagram illustrating a relay system 500 for improving QoS in an end-to-end network connection in accordance with various embodiments. With reference to FIGS. 1-5, the relay system 500 may include a 5G Relay WireLess Tethered AR (WLAR) UE 506 including a 5G WLAR 502 (i.e., including an endpoint UE (e.g., wireless device 174, 184)) and an intermediary UE 504 (e.g., UE 172a, 182a), a Cloud/Edge network 508 communicably connected to the 5G Relay WLAR UE 506 via a 5G network (e.g., 5G core network 172c, 182c), and an endpoint server 510 (e.g., application server 176, 188) providing an AR/MR/XR application. An endpoint UE (not shown) may be mapped to the 5G WLAR 502, and the intermediary UE 504 may be mapped together with the 5G WLAR 502 to the 5G Relay WLAR UE 506. The relay system 500 may determine QoS information concerning non-5G networks such as wireless connection 501 (e.g., Wi-Fi communication link 173, 183) and endpoint server network connection 507 (e.g., wired communication link 177, 189), that may be reported to, measured by, or otherwise determined by a network element (e.g., network element 402) of a 5G network for adjusting one or more QoS parameters based on a QoS requirement provided to the 5G WLAR 502 by the 5G network.

The 5G WLAR 502 may be a head-mounted display (HMD) or other type of AR/MR/XR glasses or device for implementing an AR/MR/XR application to provide a user with a certain QoE. The 5G WLAR 502 may include functional blocks AR Runtime 502a, Lightweight Scene Manager 502b, Media Client 502c, and Basic AR/MR/XR Application 502d. The AR Runtime 502a may receive sensor information and camera information from various sensors of the endpoint device (e.g., wireless device 174, 184) mapped to the 5G WLAR 502. The AR Runtime 502a may include functional blocks Vision Engine/SLAM, Pose Correction, and Soundfield mapping to generate and output an AR/MR/XR experience to the display and speakers of the 5G WLAR 502 based on AR data received from the basic AR/MR/XR application 502d. The Lightweight Scene Manager 502b may include functional blocks Basic Scene Graph Handler and Compositor to aid the AR Runtime 502a in generating the AR/MR/XR experience based on AR data received from the basic AR/MR/XR application 502d. The basic AR/MR/XR application 502d may receive user input for selecting various AR/MR/XR applications, features, and options, and the basic AR/MR/XR application 502d may request and receive AR/MR/XR data based on the user input from the endpoint server 510 across the end-to-end network connection. The Media Client 502c may include functional blocks Scene Description Delivery, Content Delivery, and Basic Codecs. The Media Client 502c may support media access functions to support the delivery of media content components over the end-to-end network connection including the 5G network connection 505 and the wireless connection 501. In some embodiments, the wireless connection 501 may be a Wi-Fi BLE, or sidelink connection. Media access functions may include 5GMS (5G Media Streaming) functions, MTSI (Multimedia Telephony Service over IMS) functions, web-connectivity or edge-related client functions, among other media access functions. For example, the Media Client 502c may request and receive AR/MR/XR application content information from a Media AS 508a-2 of the Cloud/Edge network 508, and may communicate AR/MR/XR application content information and associated requests with the AR Runtime 502a.

The intermediary UE 504 may act as a relay device to relay IP packets between the 5G WLAR 502 and the Cloud/Edge network 508 and endpoint server 510 to allow the 5G WLAR 502 to run AR/MR/XR applications based on application information stored by the endpoint server 510. The intermediary UE 504 may include a Media Session Handler 504a that includes Edge functionalities to support QoS control on the 5G System (i.e., adjusting a QoS parameters to effectuate a change in the QoS provided to the 5G Relay WLAR UE 506). To support proper QoS of the end-to-end network connection of the relay system 500, the Media Session Handler 504a may take into account the constraints of the tethering link (i.e., wireless connection 501) to provide sufficient QoS on the 5G network connection 505 to provide adequate QoE for the end user.

The Cloud/Edge network 508 may include functional blocks Media Delivery Functions 508a and AR/MR/XR application 508b. The Media Delivery Functions 508a may include functional blocks Media Application Function (AF) 508a-1 and Media Application Server (AS) 508a-2, which may include functional blocks Content Delivery, Scene Description, Decoders, and Encoders. The Media AF 508a-1 may communicate with the Media Session Handler 504a of the intermediary UE 504 across the 5G network connection 505 for purposes of establishing the end-to-end network connection of the relay system 500, such as a pose-to-render-to-photon loop 503. The Media AS 508a-2 may relay, via the intermediary UE 504, AR/MR/XR content to the Media Client 502c of the 5G WLAR 502. The AR/MR/XR application 508b may include functional blocks AR Functions, Semantical Perception, Social Integration, Media Assets storage, and AR Scene Manager 508b-1. The AR Scene Manager 508b-1 may include functional blocks Scene Graph Generator, Immersive Visual Renderer, and Immersive Audio Renderer. The endpoint server 510 may be communicably coupled to the Cloud/Edge network 508 via the endpoint server network connection 507, and may provide the AR/MR/XR application 508b with updates to application files.

A pose-to-render-to-photon loop 503 may be established across the end-to-end network connection illustrated in FIG. 5A. For example, the Media Client 502c, Media Session Handler 504a, and Media Delivery Functions 508a may communicate via the wireless connection 501 and 5G network connection 505 to establish a stable and constant communication path as the pose-to-render-to-photon loop 503. Thus, the pose-to-render-to-photon loop 503 may include four wireless links (i.e., two between the 5G WLAR 502 and intermediary UE 504, two between the intermediary UE 504 and the Cloud/Edge network 508) for communicating AR/MR/XR information across the end-to-end network connection. For example, the intermediary UE 504 may relay a request for AR/MR/XR information for an AR/MR/XR application from the 5G WLAR 502 to the Cloud/Edge network 508 via the pose-to-render-to-photon loop 503. The AR/MR/XR application 508b (i.e., the AR Scene manager 508b-1) may receive, process, and respond to the request by transmitting the associated AR/MR/XR information to the 5G WLAR 502 via the pose-to-render-to-photon loop 503.

In various embodiments, a network element within an end-to-end network connection may determine a QoS requirement of the end-to-end network connection. The QoS requirement of an end-to-end network connection may be based in part on the QoS requirement (e.g., bandwidth, bit rate, packet error rate, etc.), or data needs, of a UE. When establishing a connection between a UE located within a non-5G network (e.g., 5G WLAR 502) of the end-to-end network connection and a telecommunications network such as a 5G core network, the UE may provide a network element within the telecommunications network with a QoS requirement outlining the basic data needs of the UE. For example, the UE may inform the network element that the UE implements streaming video applications, and the network element may configure the telecommunications network to provide a QoS that is common among streaming video services. In some embodiments, the network element may detect a device or application type of the UE and may configure the 5G network. The network element may configure the 5G network based on the QoS requirement of the UE, therefore providing a generalized QoS to the endpoint UE. However, outside of the 5G network within a non-5G network in which the endpoint UE is located, the actual endpoint QoS may be unknown to the 5G network. The 5G network may have no visibility of and no direct control over the non-5G networks, and therefore may not be able to optimize the QoS provided to the endpoint UE via the 5G network. For example, the 5G network, as configured by the network element, may overprovision QoS to the UE based solely on a QoS requirement received from a UE, such that the UE is provided with an excess of resources (e.g., too much bandwidth, bit rate; low packet rate, etc.), therefore wasting 5G network resources. As another example, the 5G network, as configured by the network element, may not provision the UE with sufficient QoS. In this case, the QoE of a user of the endpoint UE may be poor, but the network element of the 5G network would be unaware of the poor QoS experienced within the non-5G network. Various embodiments allow for a network element of a 5G network to indirectly optimize QoS experienced by an endpoint UE of a non-5G network based on QoS information provided to the network element from devices or reporting entities within non-5G networks.

FIG. 5B is a message flow diagram illustrating call flows that may occur in the relay system architecture illustrated in FIG. 5A. With reference to FIGS. 1A-5B, in this architecture, the intermediate UE 504 is not involved in the processing of the media as it acts as a relay between the network and the AR glasses 502. To ensure desired end-to-end QoS, the UE 504 monitors and estimates the QoS of the link (e.g., a Wi-Fi link) with the AR glasses 502, determines the QoS requirements on the 5G system, and makes a QoS request to the PDU session setup process. Specifically, initiation of an AR application executing an AR glasses 502 may begin by the application initiating a device discovery message exchange 1 to detect and establish a wireless connection with an intermediary UE 504. Once a wireless connection is established with the intermediary UE 504, the AR application executing in the AR glasses 502 may initiate an edge discovery request and message 2 via the media session handler 504a (“MSH” in FIG. 5B) executing in the intermediary UE 504. The intermediary UE 504 through the media session handler 504a may initiate an edge discovery and connection message exchange 3 with an edge application server 508 via the user plane function 510 (UPF) of a 5G network.

With a communication connection established with the edge application server 508, the application executing in the AR glasses 502 may send a media capability message 4 via the connection to the edge application server 508. Informed of the media capabilities of the AR glasses 502, the edge application server 508 and the AR glasses 502 may exchange split rendering configuration messages 5 to arrive at a partitioning of the rendering processing tasks between the AR glasses 502 at the edge application server 508 (and possibly the intermediate UE 504). The configuration established, the application executing in the AR glasses 502 may initiate the AR application and message 6.

To begin supporting the AR application, the intermediate UE 504, via the wireless connection to the AR glasses 502 and the media session handler 504a connection with the user plane function 510, may estimate the quality of service (QoS) of the Wi-Fi link to the AR glasses in operation 7. Via the media session handler 504a connection with the user plane function 510, the intermediate UE 504 may communicate a request for a QoS level necessary to support the AR application as well as set up a Protocol Data Unit (PDU) session in operation 8. Thereafter, the AR application executing in the AR glasses 502 may transmit camera feeds, audio data and pose information in a data stream 9 to the edge application server 508, which may use such upload data to generate audio and video AR media that it downloads to the AR glasses 502 in a video/audio/scene graph data stream 10.

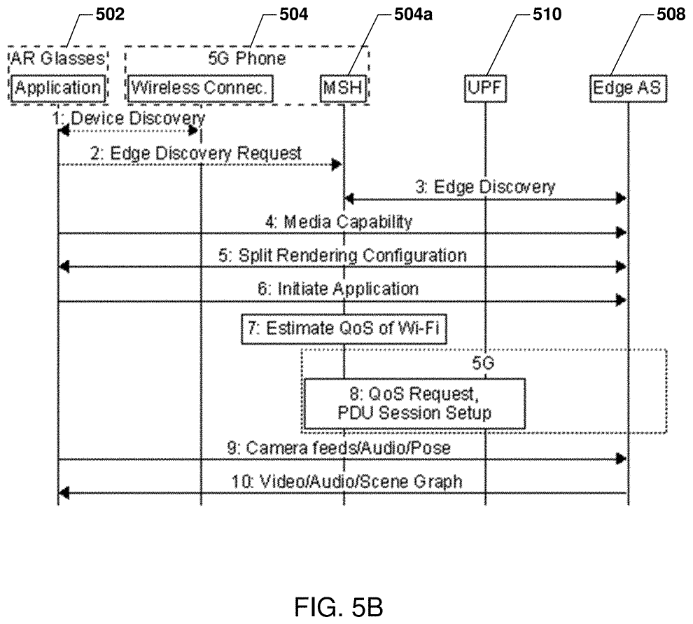

FIGS. 6A-6C are component block diagrams illustrating system architectures 600a-600c for improving QoS in an end-to-end network connection in accordance with various embodiments. With reference to FIGS. 1-6C, the system architectures 600a-600c as illustrated in FIG. 6A may include an endpoint UE 602 (e.g., e.g., wireless device 174, 184) an intermediary UE 604 (e.g., UE 172a, 182a, intermediary UE 504), a gNB 606 (e.g., gNB 172b, 182b), a Non-3GPP Interworking Function (N3IWF) 608, a User Plane Function (UPF) 610 (e.g., 172d, 182d), and an endpoint server 612 (e.g., application server 176, 188, endpoint server 510). In some embodiments implementing the components of FIG. 5A, the endpoint UE 602 may be mapped to the 5G WLAR 502, the intermediary UE 604 may be mapped to the intermediary UE 504, and the endpoint UE 602 and the intermediary UE 604 may be mapped to the 5G Relay WLAR UE 506.

The system architectures 600a-600c may represent various end-to-end telecommunications network architectures in which QoS information may be measured and/or recorded by and subsequently reported from an endpoint device (e.g., endpoint UE 602, endpoint server 612) within a non-5G network to a network element (e.g., e.g., network element 402) within a 5G network (e.g., 5G core network 172c, 182c) for purposes of adjusting a QoS parameter of the 5G network based on a QoS requirement of the endpoint device (i.e., within the end-to-end network connection) and the reported QoS information. With reference to FIGS. 6A-6C, the network element may be a device, component, functional block, or any other entity within the gNB 606, N3IWF 608, UPF 610, or 5G network containing the gNB 606, N3IWF 608, and UPF 610.

With reference to FIG. 6A, the endpoint UE 602 may be partially managed by 3GPP (i.e., 3GPP manages higher layers) via N3IWF 608. The N3IWF 608 may utilize the interface Y1 between the endpoint UE 602 and the intermediary UE 604, and the interface Y2 between the intermediary UE 604 and the N3IWF 608 to partially manage the endpoint UE 602. In a system architecture 600a in which the endpoint UE 602 is partially managed by 3GPP, the endpoint UE 602, the intermediary UE 604, or both the endpoint UE 602 and intermediary UE 604 may measure, record, or otherwise obtain QoS information describing the status and properties of the QoS of the non-5G network. For example, the endpoint UE 602 and/or the intermediary UE 604 (e.g., via the Media Session Handler 504a) may collect QoS information, such as round-trip delay, one-way delay, and/or packet error rate, of the non-5G network (e.g., Wi-Fi, Bluetooth connection between endpoint UE 602 and intermediary UE 604) and report the obtained QoS information to a network element of the 5G network (e.g., N3IWF 608).

With reference to FIG. 6B, the endpoint UE 602 may not be managed by 3GPP, and may instead be managed independently from 3GPP. In a system architecture 600b in which the endpoint UE 602 is managed independently from 3GPP, the intermediary UE 604 may measure, record, or otherwise obtain QoS information describing the status and properties of the QoS of the non-5G network. For example, the intermediary UE 604 (e.g., via the Media Session Handler 504a) may inform the 3GPP network of the presence of the endpoint UE 602 via a non-3GPP network (e.g., Wi-Fi, Bluetooth). The intermediary UE 604 may then collect QoS information of the non-5G network (e.g., Wi-Fi, Bluetooth connection between endpoint UE 602 and intermediary UE 604) and report the obtained QoS information to a network element of the 5G network such as the Media AF 508a-1, an access and mobility management function (AMF), or a policy and charging function (PCF). The PCF may control a service agreement and may determine which 5G QoS is provided to the 5G network. The PCF (not shown), may be connected to the AMF (not shown), which in turn may be connected to the Media AF 508a-1.

With reference to FIG. 6C, the endpoint UE 602 may be fully managed by 3GPP. In a system architecture 600a in which the endpoint UE 602 is completely managed by 3GPP (e.g., via PC5 interface, sidelink), the endpoint UE 602, the intermediary UE 604, or both the endpoint UE 602 and intermediary UE 604 may measure, record, or otherwise obtain QoS information describing the status and properties of the QoS of the non-5G network. For example, the endpoint UE 602 and/or the intermediary UE 604 (e.g., via the Media Session Handler 504a) may collect QoS information of the non-5G network (e.g., Wi-Fi, Bluetooth connection between endpoint UE 602 and intermediary UE 604) and report the obtained QoS information to a network element of the 5G network (e.g., Media AF 508a-1, AMF, or PCF).

The system architectures 600a-600c describe various methods for obtaining QoS information of non-5G network and reporting the obtained QoS information, via a reporting entity (e.g., endpoint UE 602, intermediary UE 604), to a network element in a 5G network for further processing. In some embodiments, QoS information may include QoS-related information of non-5G networks (e.g., Wi-Fi, BLE, sidelink) including characteristics or metrics such as round-trip time or delay, one-way delay, or packet error rate. QoS information may further include a classification of a non-5G network that is part of an end-to-end connection. For example, a classification of a network connection may be a determination of whether a non-5G network is a Wi-Fi network (e.g., IEEE 802.11ad, 802.11ac), BLE, or a wired connection (e.g., USB). As another example, a classification of a network may include a QoS configuration for a non-5G network, for example Wi-Fi, which may be defined by a particular access category (e.g., Best Effort or Video) under Enhanced Distributed Channel Access (EDCA). QoS information may further include desired changes to a QoS provided to an endpoint UE 602 from a 5G telecommunications network. For example, an endpoint UE 602 may report desired changes to a network element of a 5G network that provisions the endpoint UE 602 with a certain level of QoS, and the desired changes may include a decrease in the amount of delay (e.g., round-trip delay, one-way delay) or packet error rate, and/or the amount of delay (e.g., round-trip delay, one-way delay) or packet error rate that is allowed to be increased without violating a Quality of Experience (QoE) of the endpoint UE 602.

QoS information may further include measured metrics between a telecommunications network and an application, or endpoint, server, including one-way delay from the telecommunications network to the application server, one-way delay from the application server to the telecommunications network, round-trip delay between the telecommunications network and the application server, packet error rate from the telecommunications network to the application server, and/or packet error rate from the application server to the telecommunications network. For example, a network element within a 5G core network may measure the time delay metrics to and from an endpoint server (e.g., endpoint server 510, 612). The measurement performed by the network element may be active, in which the network element may transmit probe packets such as ping messages for round-trip delay between the network element and the endpoint server 612 and/or timestamp messages to determine round-trip delay and/or one-way delay. For example, a network element within a 5G core network may generate a timestamp message with a timestamp indicating the time of origin (To).

In response to receiving the timestamp message indicating the To from the network element, the endpoint server 612 may generate a timestamp reply message with a timestamp for the receiving time (Tr). The timestamp reply message may also include a timestamp indicating the To and a timestamp for the time of transmitting (Tt) of the timestamp reply message. The endpoint server 612 may then transmit the timestamp reply message to the network element within the 5G core network that originally transmitted the timestamp message including the To.

In response to receiving the timestamp reply message from the endpoint server 612, the network element may generate a timestamp indicating a receipt, or final, time (Tf). The network element may then calculate any of the following: (i) one-way delay from the network element within the 5G core network to the endpoint server 612 (i.e., one-way delay=Tr−To); (2) one-way delay from the endpoint server 612 to the network element (i.e., one-way delay=Tf−Tt); (3) round-trip delay between the network element and the endpoint server 612 (i.e., round-trip delay=Tf−To, or Tf−Tt+Tr−To). In some embodiments, the measurement of round-trip delay and/or one-way delays may be passive by recording local time stamps of passing packets and the corresponding returning packets. In some embodiments, the measurement of the time delays between the network element and the endpoint server 612 may be performed by network entities such as the Media AF 508a-1, the Media AS 508a-2, and/or UPF 610.

QoS information may further include information about an application being run on an endpoint UE 602, such as the video codec, audio codec, bit rates, frame rate, latency (e.g., for doing rendering, for detecting a pose change), or QoS requirements (e.g., on throughput and/or latency). QoS information may further include information about network traffic, such as whether the traffic is symmetric between uplink and downlink, whether the uplink traffic is mainly light commands and pose but delay stringent, and whether the downlink traffic is mainly heavy multimedia content but with a less stringent delay requirement. For example, QoS information including application information and/or traffic information may be obtained via the various system architectures 600a-600c (e.g., 5G Relay WLAR UE 506), and may then be reported to a network element within the 5G network via the Media Session Handler 504a and/or the Media Client 502c.

QoS information may further include a time delay between an endpoint UE 602 and a device hosting a renderer function for purposes of augmented reality (AR), mixed reality (MR), or extended reality (XR) applications (e.g., intermediary UE 604, endpoint server 612).

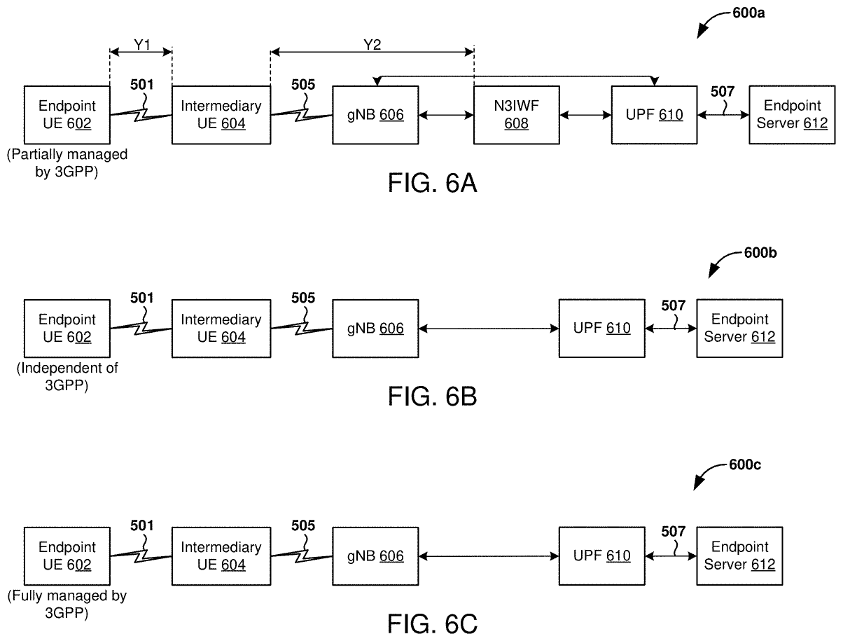

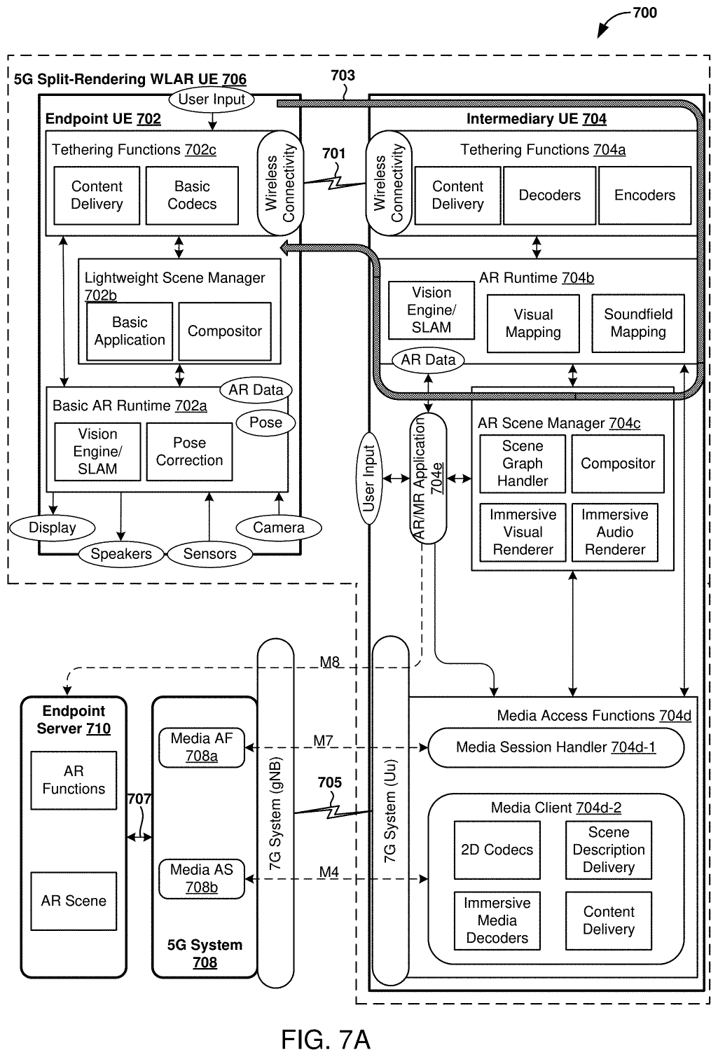

FIG. 7A is a component block diagram illustrating a split-rendering system 700 for improving QoS in an end-to-end network connection in accordance with various embodiments. In split-rendering architectures, non-5G network QoS information such as time delay between multiple devices that perform rendering operations for a same output may be useable by a network element to better optimize, via adjusting a QoS parameter of the 5G network, the QoS experienced by the non-5G networks within an end-to-end connection.

With reference to FIGS. 1-7A, the split-rendering system 700 may include a 5G Split-Rendering WireLess Tethered AR (WLAR) UE 706 including an endpoint UE 702 (e.g., wireless device 174, 184, endpoint UE 602), an intermediary UE 704 (e.g., UE 172a, 182a, intermediary UE 504, 604), a 5G System 708 communicably connected to the 5G Split-Rendering WLAR UE 706 via a 5G network (e.g., 5G core network 172c, 182c), and an endpoint server 710 (e.g., application server 176, 188, endpoint server 510, 612) providing an AR/MR/XR application. The endpoint UE 702 and the intermediary UE 704 may be mapped together to the 5G Split-Rendering WLAR UE 706. The system 700 may determine QoS information concerning non-5G networks such as wireless connection 701 (e.g., Wi-Fi communication link 173, 183, wireless connection 501) and endpoint server network connection 707 (e.g., wired communication link 177, 189, endpoint server network connection 507) that may be reported to, measured by, or otherwise determined by a network element (e.g., network element 402) of a 5G network for adjusting one or more QoS parameters based on a QoS requirement provided to the endpoint UE 702 by the 5G network.

The endpoint UE 702 may be an HMD or other type of AR/MR/XR glasses or device for implementing an AR/MR/XR application to provide a user with a certain QoE. The endpoint UE 702 may include functional blocks Basic AR Runtime 702a, Lightweight Scene Manager 702b, and Tethering Functions 702c. The Basic AR Runtime 702a may receive sensor information and camera information from various sensors of the endpoint UE 702. The Basic AR Runtime 702a may include functional blocks Vision Engine/SLAM and Pose Correction to generate and output an AR/MR/XR experience to the display and speakers of the endpoint UE 702 based at least on additional AR/MR/XR data received from another device or component hosting a renderer application. The Lightweight Scene Manager 702b may include functional blocks Basic Application and Compositor to aid the AR Runtime 702a in generating the AR/MR/XR experience based on AR data received from another rendering device through the Tethering Functions 702c. The Tethering Functions 702c may receive user input for selecting various AR/MR/XR applications, features, and options, and the basic AR Runtime 702a may request and receive AR/MR/XR data based on the user input from the endpoint server 710 and/or another rendering device across the end-to-end network connection. The Tethering Functions 702c may include functional blocks Content Delivery and Basic Codecs. The Tethering Functions 702c may support wireless communications functions to support the delivery of media content components over the end-to-end network connection including the 5G network connection 705 and the wireless connection 701. For example, the Tethering Functions 702c may request and receive rendered AR/MR/XR application content information from an AR Scene Manager 704c of the intermediary UE 704 (i.e., intermediary UE is performing rendering processes to be used in split-rendering applications), and may communicate AR/MR/XR application content information and associated requests with the AR Runtime 702a.

The intermediary UE 704 may act as a device hosting a renderer application to render data that may be used in conjunction with application data rendered by the endpoint UE 702. The intermediary UE 704 may include functional blocks Tethering Function 704a, AR Runtime 704b, AR Scene Manager 704c, Media Access Functions 704d, and AR/MR/XR Application 705e. The Tethering Functions 704a may include functional blocks Content Delivery, Decoders, and Encoders to relay AR/MR/XR information to the Tethering Functions 702c of the endpoint UE 702 via the wireless connection 701. The AR Runtime 704b may include functional blocks Vision Engine/SLAM, Visual Mapping, and Soundfield Mapping to render AR/MR/XR content usable by the endpoint UE 702 to generate and output an AR/MR/XR experience to the display and speakers of the endpoint UE 702. The AR Scene Manager 704c may include functional blocks Scene Graph Handler, Compositor, Immersive Visual Renderer, and Immersive Audio Renderer to aid the AR Runtime 704b in generating the split-rendered AR/MR/XR content experience based on AR data received from the AR/MR/XR Application 702e. The AR/MR/XR application 702e may receive user input for selecting various AR/MR/XR applications, features, and options, and the AR/MR/XR application 702e may request and receive AR/MR/XR data based on the user input from the endpoint server 710 across the end-to-end network connection. The Media Access Functions 704d may include functional blocks Media Session Handler 704d-1 and Media Access Functions 704d-2. The Media Client 704d-2 may include functional blocks 2D Codecs, Scene Description Delivery, Immersive Media Decoders, and Content Delivery. The Media Access Functions 704d may support media access functions to enable the request and delivery of media content components over the end-to-end network connection including the 5G network connection 705. For example, the Media Session Handler 704d-1 and the Media Client 704d-2 may include functionalities to support establishing a 5G network connection with the 5G System 708 (i.e., to the Media AF 708a and the Media AS 708b of the 5G System 708).

The 5G System 708 may include functional blocks Media AF 708a and the Media AS 708b. The Media AF 708a and the Media AS 708b may communicate AR/MR/XR application information from the endpoint server 710 to the intermediary UE 704 and/or to the endpoint UE 702 for performing split-rendering processes.

The endpoint server 710 may be communicably coupled to the 5G System 708 via the endpoint server network connection 707, and may provide the AR/MR/XR application 704e with updates to application files that may be distributed to various components of the intermediary UE 704. In some embodiments, the endpoint server 710 may host a renderer application, and may perform split-rendering processes to produce AR/MR/XR content that may be combined with application content rendered by the endpoint UE 702 to output a complete AR/MR/XR experience. For example, the endpoint server 710 may include functional blocks AR Functions 710a and AR Scene 710b that may perform AR/MR/XR rendering functions similar to that of Basic AR Runtime 702a and Lightweight Scene Manager 702b of the endpoint UE 702, and AR Runtime 704b and AR Scene Manager 704c of the intermediary UE 704.

A pose-to-render-to-photon loop 703 may be established across the end-to-end network connection as illustrated in FIG. 7A. For example, the Tethering Functions 702c may communicate via the wireless connection 701 to establish a stable and constant communication path as the pose-to-render-to-photon loop 703. Thus, the pose-to-render-to-photon loop 703 may include two wireless links (i.e., two between the endpoint UE 702 and intermediary UE 704) for communicating split-rendering AR/MR/XR information across the wireless connection 701. For example, the endpoint UE 702 may transmit pose information (e.g., 3D orientation, accelerometer information, additional sensor information) to the intermediary UE 704 via the pose-to-render-to-photon loop 703. The AR Scene manager 704c receive the pose information, and in response, generate and transmit, via the pose-to-render-to-photon loop 703, split-rendered AR/MR/XR data corresponding to the pose information to the endpoint UE 702 for developing a full AR/MR/XR experience. In some embodiments in which the endpoint server 710 may host split-rendering functionality, the pose-to-render-to-photon loop 703 may extend across the 5G network connection 705 to allow for split-rendered requests (i.e., from the endpoint UE 702) and content (i.e., from the intermediary UE 704 and/or the endpoint server 710) to be conveyed between the endpoint UE 702 and the endpoint server 710.

In some embodiments, obtaining, calculating, or otherwise determining a delay between the endpoint UE 702 (e.g., rendering device such as glasses, HMD, etc.) and a device hosting a renderer function (i.e., intermediary UE 704, endpoint server 710) may be usable by a network element of the 5G network to improve the QoS of non-5G networks within an end-to-end connection (i.e., from endpoint UE 702 to endpoint server 710). Based on QoS information including a delay between the endpoint UE 702 and a device hosting a renderer function, a network element may adjust a QoS parameter of the 5G network to effectuate an optimization change within the 5G network to indirectly provide an improved, or a sufficient, QoS to the non-5G networks.

In some embodiments, the transmission delay may be measured by the endpoint UE 702 based on round-trip time measurements between the endpoint UE 702 and the device hosting the render (i.e., intermediary UE 704, endpoint server 710), or may be based on one-way delay measurements with the aid of timestamps. In some embodiments, the transmission delay may be measured by a network element located or processed with the 5G network and is closest to the endpoint UE 702, (e.g., an intermediary UE 704 operating as a 5G phone). In some embodiments, the device measuring the delay (e.g., endpoint UE 702, or intermediary UE 704) may report the measured delay to a network element within the 5G core network and/or to a device hosting the split-rendering function. The delay (“D”) may be used by the device hosting the renderer function to predict the time corresponding to the rendered content (e.g., video, audio), such that any content rendered by the split-rendering device may transmit the rendered content to the endpoint UE 702 in time to enable the endpoint UE 702 to generate a complete AR/MR/XR experience by combining the received rendered content with corresponding content locally rendered by the endpoint UE 702. For example, the device hosting the renderer function may predict a pose “x” seconds into the future and render content in preparation for that pose, where x=rendering delay (i.e., time to render content)+D+display delay (i.e., of the endpoint UE 702). In some embodiments, the delay may be relayed or reported to a network element of the 5G network to determine whether a QoS parameter of the 5G network may be adjusted to facilitate a reduced delay “D” or to reallocate 5G network resources if a longer delay “D” can be tolerated without affecting the QoE observed by a user of the endpoint UE 702.

In some embodiments implementing a system 700 including the 5G Split-Rendering WireLess Tethered AR (WLAR) UE 706, for purposes of determining a delay between an endpoint device and a device hosting the renderer, the endpoint device may be mapped to the endpoint UE 702, and the device hosting the renderer may be mapped to the intermediary UE 704 (e.g., 5G phone). The intermediary UE 704 may therefore receive the delay information from the endpoint UE 702, and may relay the delay information to a network element within the 5G network as described with reference to FIGS. 6A-6C. For example, the delay may be reported to a network element in a system implementing system architecture 600a, in which the endpoint UE 602 (e.g., 702) is partially managed by 3GPP via the N3IWF 608. As another example, the delay may be reported to a network element in a system implementing system architecture 600b, in which the endpoint UE 602 (e.g., 702) is managed independently from 3GPP. As a further example, the delay may be reported to a network element in a system implementing system architecture 600c, in which the endpoint UE 602 (e.g., 702) is fully managed by 3GPP via PC5 sidelink.

In some embodiments implementing a relay system 500 including the 5G Relay WireLess Tethered AR (WLAR) UE 506, for purposes of determining a delay between an endpoint device and a device hosting the renderer, the endpoint device may be mapped to the 5G WLAR 502, and the device hosting the renderer may be mapped to the Cloud/Edge (e.g., Cloud/Edge network 508, endpoint server 510). The Cloud/Edge hosting the renderer may therefore receive the delay information from the 5G WLAR 502, and may relay the delay information to a network element within the 5G network as described with reference to FIGS. 6A-6C. For example, the delay may be reported to a network element in a system implementing system architecture 600a, in which the endpoint UE 602 (e.g., 502) is partially managed by 3GPP via the N3IWF 608. As another example, the delay may be reported to a network element in a system implementing system architecture 600b, in which the endpoint UE 602 (e.g., 502) is managed independently from 3GPP. As a further example, the delay may be reported to a network element in a system implementing system architecture 600c, in which the endpoint UE 602 (e.g., 502) is fully managed by 3GPP via PC5 sidelink.

In various embodiments, a network element within a telecommunications network may adjust a QoS parameter of the telecommunications network communication network based on a QoS requirement of an endpoint UE (e.g., 5G WLAR 502, endpoint UE 602, endpoint UE 702) and QoS information obtained from non-5G networks within the same end-to-end network connection as the telecommunications network. Adjusting a QoS parameter may include configuring a 5G network to affect QoS observed within a non-5G network, to either improve the QoS of a non-5G network based on the received QoS information and the QoS requirement, or to allocate fewer resources to an endpoint UE after determining fewer 5G resources would be sufficient and the QoE observed at the endpoint UE would not be negatively affected by resource reallocation. In some embodiments, adjusting a QoS parameter may include adjusting a 5QI of the 5G network.

FIG. 7B is a message flow diagram illustrating call flows that may occur in the relay system architecture illustrated in FIG. 7A. With reference to FIGS. 1A-7B, in this architecture, the Media Session Handling (MSH) 704 executing in the intermediate UE 704 handles the edge discovery. The link between the AR glasses 702 and the intermediate UE 704 may be a Wi-Fi link as illustrated, but could be a 3GPP sidelink via the PC5 interface. The 5G system represented by the user plane function (UPF) 708 is involved at the beginning of the call flow in message exchanges 2 through 4. The edge discovery process is illustrated as driven by the application, but it could be driven by the network (in which case the edge discover request message 2 may be left out). After the media software has been downloaded in message exchanges 4, all the processing and communication may be between the AR glasses 702 and the intermediate UE

Specifically, initiation of an AR application executing the intermediate UE 704 may begin with device discovery message exchanges 1 between a tethering function 704a executing in the UE 714 and the AR glasses 702 to establish a wireless connection between the two devices. Once a wireless connection is established with the AR glasses 702, the AR application 704b executing in the intermediary UE 704 may initiate an edge discovery request 2 to the media session handler 704d (“MSH” in FIG. 7B) executing in the intermediary UE 704. The intermediary UE 704 through the media session handler 704b may initiate an edge discovery and connection message exchange 3 with an edge application server 710 via the user plane function 708 (UPF) of a 5G network.

With a communication connection established with the edge application server 710, the application 704b executing in the intermediary UE 704 download media software from the edge application server 710 via the user plane function 708 in message exchange 4.

At this point, the AR glasses 702 may send a media capability message 5 to the application 704b executing in the intermediary UE 704. Informed of the media capabilities of the AR glasses, the application 704b executing in the intermediary UE 704 and the AR glasses 702 may exchange functional split negotiation messages 6 to arrive at partitioning of the rendering processing tasks between the AR glasses 702 and the application 704b executing in the intermediary UE 704. As an example of a functional split, the intermediary UE 704 may request use of the display of the AR glasses 702.

The split configuration established, the application 704b executing in the intermediary UE 704 may initiate the AR application message 7. Thereafter, the AR glasses 702 may transmit camera feeds, audio data and pose information in a data stream 8 to the application 704b executing in the intermediary UE 704, which may use such upload data to generate audio and video AR media that it downloads to the AR glasses 702 in a video/audio/scene graph data stream 9.

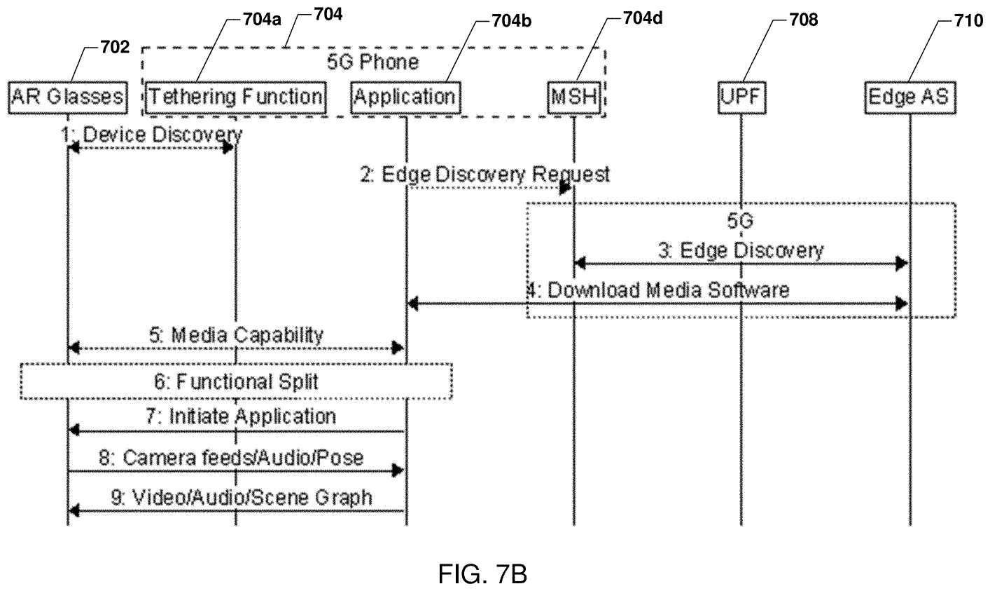

FIG. 8 is a process flow diagram illustrating an embodiment method 800 for improving QoS in an end-to-end network connection including a first communication network and a second communication network according to various embodiments. With reference to FIGS. 1-8, the method 800 may be implemented in a processor (e.g., processors 212, 214, 216, 218, 252, 260, 428) configured to perform operations of the method. In various embodiments, the processor (e.g., processors 212, 214, 216, 218, 252, 260, 428) may be configured to perform the operations by processor-executable instruction stored in a non-transitory processor-readable medium (e.g., memory devices 220, 258, electronic storage 426). Means for performing each of the operations of the method 800 may be a processor of the wireless modem system 200 and/or network element 402, such as the processors 212, 214, 216, 218, 252, 260, 428 and/or the like.

In block 802, a network element within the end-to-end network connection may determine a QoS requirement of the end-to-end network connection. In various embodiments, the network element (e.g., network element 402) may determine a QoS requirement of an end-to-end network connection based on QoS needs of an endpoint UE (e.g., wireless device 174, 184, endpoint UE 602, 702) located within the second network (e.g., non-5G network). In some embodiments, determining, by the network element within the end-to-end network connection, the QoS requirement of the end-to-end network connection may include determining, by the network element, a QoS requirement of the end-to-end network connection based on a service agreement, application type, or user request. In some embodiments, the first communication network may be a 5G network (e.g., 5G core network 172c, 182c) and the second communication network may not be a 5G network (i.e., non-5G network). Means for performing each of the operations in block 802 may include a processor of the wireless modem system 200 and/or network element 404, such as the processors 212, 214, 216, 218, 252, 260, 428 and/or the like.

In block 804, the network element may obtain QoS information of the second communication network from a reporting entity within the second communication network. In various embodiments, the network element (e.g., network element 402) may receive, determine, or otherwise obtain QoS information from a reporting entity (e.g., wireless device 174, 184, endpoint UE 602, 702, UE 172a, 182a, intermediary UE 504, 604, 704, application server 176, 188, endpoint server 510, 612, 710) within the second communication network (e.g., non-5G network).

In some embodiments, QoS information may include at least one of a round-trip delay of the end-to-end network connection, a one-way delay of the end-to-end network connection, or a packet error rate provided to the reporting entity. In some embodiments, the QoS information may include a classification of the second communication network. In some embodiments, the QoS information may include a request message indicating a requested change in a round-trip delay of the end-to-end network connection, a one-way delay of the end-to-end network connection, or a packet error rate provided to the reporting entity. In some embodiments, QoS information may include at least one of application information or traffic information.

In some embodiments, obtaining, by the network element, QoS information of the second communication network from the reporting entity within the second communication network may include measuring a delay between the first communication network (e.g., 5G core network 172c, 182c) and an endpoint server (e.g., application server 176, 188, endpoint server 510, 612, 710) within the second communication network. In some embodiments, the network element may be located within the second communication network, and obtaining, by the network element, QoS information of the second communication network from the reporting entity within the second communication network may include measuring a delay between the reporting entity and the network element. In some embodiments, the network element may be located within a third communication network (e.g., non-5G network) that is communicably connected to the second communication network through the first communication network, and obtaining, by the network element, QoS information of the second communication network from the reporting entity within the second communication network may include measuring a delay between the reporting entity and the network element. In some embodiments, the network element may be located within the first communication network, and obtaining, by the network element, QoS information of the second communication network from the reporting entity within the second communication network may include measuring a delay between the reporting entity and the network element.

Means for performing each of the operations in block 804 may include a processor of the wireless modem system 200 and/or network element 404, such as the processors 212, 214, 216, 218, 252, 260, 428 and/or the like.

In block 806, the network element may adjust a QoS parameter of the first communication network based on the determined QoS requirement and the obtained QoS information. In various embodiments, the network element (e.g., network element 402) may adjust a QoS parameter of the first communication network (e.g., 5G core network 172c, 182c) based on the QoS requirement determined in block 802 and the QoS information obtained in block 804. In some embodiments, adjusting, by the network element, the QoS parameter of the first communication network based on the determined QoS requirement and the obtained QoS information may include adjusting, by the network element, a 5G QoS parameter (e.g., 5QI) of the first communication network. Means for performing each of the operations in block 806 may include a processor of the wireless modem system 200 and/or network element 404, such as the processors 212, 214, 216, 218, 252, 260, 428 and/or the like.

The order of operations performed in blocks 802-806 is merely illustrative, and the operations of blocks 802-806 may be performed in any order and partially simultaneously in some embodiments. In some embodiments, the method 800 may be performed by a processor of a device independently from, but in conjunction with, an external memory device. For example, the method 800 may be implemented as a software module executing within a processor of an SoC or in dedicated hardware within an SoC that issues commands to establish secure memory channels and access memory of an external memory device and is otherwise configured to take actions and store data as described.

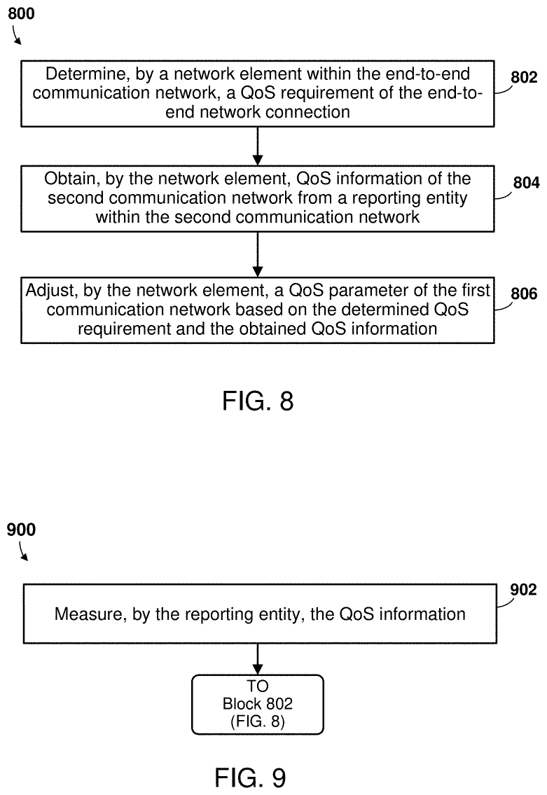

FIG. 9 is a process flow diagram illustrating an embodiment method 900 for improving QoS in an end-to-end network connection including a first communication network and a second communication network that may be implemented as part of the method 800 according to some embodiments. With reference to FIGS. 1-9, the method 900 may be implemented in a processor (e.g., processors 212, 214, 216, 218, 252, 260, 428) configured to perform operations of the method. In various embodiments, the processor (e.g., processors 212, 214, 216, 218, 252, 260, 428) may be configured to perform the operations by processor-executable instruction stored in a non-transitory processor-readable medium (e.g., memory devices 220, 258, electronic storage 426). Means for performing each of the operations of the method 800 may be a processor of the wireless modem system 200, the network element 402, or a reporting entity (e.g., wireless device 174, 184, endpoint UE 602, 702, UE 172a, 182a, intermediary UE 504, 604, 704, application server 176, 188, endpoint server 510, 612, 710) such as the processors 212, 214, 216, 218, 252, 260, 428 and/or the like.

In block 902, the reporting entity may measure the QoS information. In particular, the reporting entity (e.g., wireless device 174, 184, endpoint UE 602, 702, UE 172a, 182a, intermediary UE 504, 604, 704, application server 176, 188, endpoint server 510, 612, 710) may measure, record, and/or otherwise determine QoS information of an end-to-end network connection including non-5G networks. The reporting entity may then transmit the QoS information from the second communication network (e.g., non-5G network) to the network element (e.g., network element 402) within the first communication network (e.g., 5G core network 172c, 182c). Means for performing the operations in block 902 may be a processor of the wireless modem system 200, the network element 402, or a reporting entity (e.g., wireless device 174, 184, endpoint UE 602, 702, UE 172a, 182a, intermediary UE 504, 604, 704, application server 176, 188, endpoint server 510, 612, 710) such as the processors 212, 214, 216, 218, 252, 260, 428 and/or the like.

After performing the operations in block 902, the system may perform the operations in block 802 of the method 800 (FIG. 8) as described.

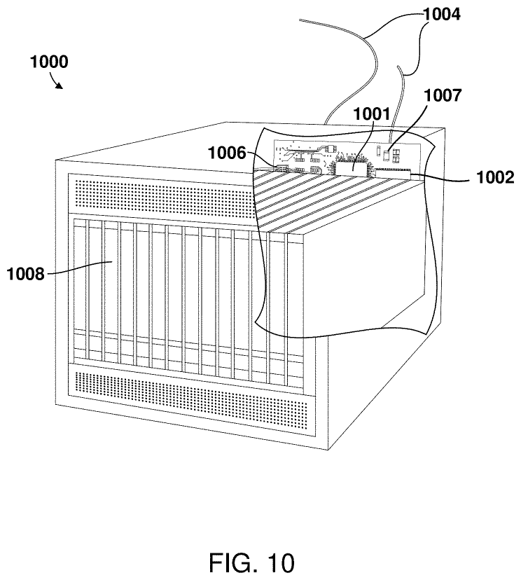

FIG. 10 is a component block diagram of a network element device suitable for use with various embodiments. Such network element devices (e.g., a network element (e.g., 402) of the core network 140 or the 5G networks 151a, 161a, 171a, and 181a, a base station device (such as the base station 110a-110d, 200, 350), and/or the like) may include at least the components illustrated in FIG. 10. With reference to FIGS. 1-10, the network element device 1000 may typically include a processor 1001 coupled to volatile memory 1002 and a large capacity nonvolatile memory, such as a disk drive 1008. The network element device 1000 also may include a peripheral memory access device 1006 such as a floppy disc drive, compact disc (CD) or digital video disc (DVD) drive coupled to the processor 1001. The network element device 1000 also may include network access ports 1004 (or interfaces) coupled to the processor 1001 for establishing data connections with a network, such as the Internet or a local area network coupled to other system computers and servers. The network element device 1000 may include one or more antennas 1007 for sending and receiving electromagnetic radiation that may be connected to a wireless communication link. The network element device 1000 may include additional access ports, such as USB, Firewire, Thunderbolt, and the like for coupling to peripherals, external memory, or other devices.

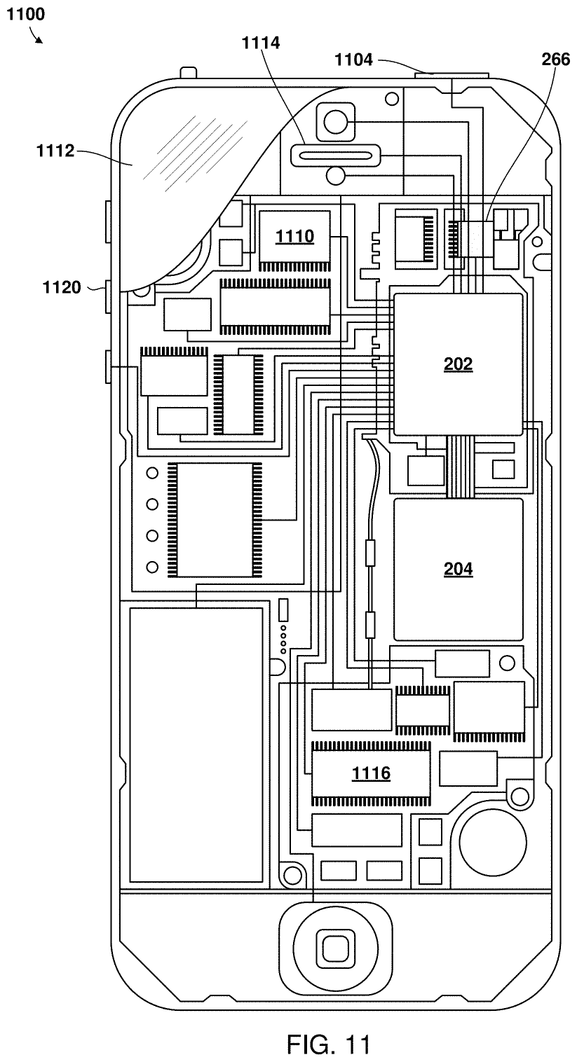

FIG. 11 is a component block diagram of a wireless device 1100 suitable for use with various embodiments. In some embodiments, the wireless device 1100 may operate as a network element. With reference to FIGS. 1-11, various embodiments may be implemented on a variety of wireless devices 1100 (for example, the wireless device 120a-120e, 200, 320, 404), an example of which is illustrated in FIG. 11 in the form of a smartphone. The wireless device 1100 may include a first SOC 202 (for example, a SOC-CPU) coupled to a second SOC 204 (for example, a 5G capable SOC). The first and second SOCs 202, 204 may be coupled to internal memory 1116, a display 1112, and to a speaker 1114. Additionally, the wireless device 1100 may include an antenna 1104 for sending and receiving electromagnetic radiation that may be connected to a transceiver 427 coupled to one or more processors in the first and/or second SOCs 202, 204. Wireless device 1100 may include menu selection buttons or rocker switches 1120 for receiving user inputs.

The wireless device 1100 wireless device 1100 may include a sound encoding/decoding (CODEC) circuit 1110, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 1110 may include a digital signal processor (DSP) circuit (not shown separately).

The processors of the network element device 1000 and the wireless device 1100 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 1002, 1116 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 800 and 900 may be substituted for or combined with one or more of the operations of the methods 800 and 900.

Implementation examples are described in the following paragraphs. While some of the following implementation examples are described in terms of example methods, further example implementations may include: the example methods discussed in the following paragraphs implemented by a base station including a processor configured with processor-executable instructions to perform operations of the methods of the following implementation examples; the example methods discussed in the following paragraphs implemented by a base station including means for performing functions of the methods of the following implementation examples; and the example methods discussed in the following paragraphs may be implemented as a non-transitory processor-readable storage medium having stored thereon processor-executable instructions configured to cause a processor of a base station to perform the operations of the methods of the following implementation examples.

Example 1. A method for improving Quality of Service (QoS) in an end-to-end network connection including a first communication network and a second communication network, including determining, by a network element within the end-to-end network connection, a QoS requirement of the end-to-end network connection, obtaining, by the network element, QoS information of the second communication network from a reporting entity within the second communication network, and adjusting, by the network element, a QoS parameter of the first communication network based on the determined QoS requirement and the obtained QoS information.

Example 2. The method of example 1, in which the first communication network is a 5G network and the second communication network is not a 5G network.

Example 3. The method of either of examples 1 or 2, in which the reporting entity is a device within the second communication network and the network element is a device within the first communication network, the method further including measuring the QoS information by the reporting entity, in which obtaining, by the network element, QoS information of the second communication network from the reporting entity within the second communication network includes receiving the QoS information from the reporting entity by the network element.

Example 4. The method of either of examples 1 or 2, in which the QoS information includes at least one of a round-trip delay of the end-to-end network connection, a one-way delay of the end-to-end network connection, or a packet error rate provided to the reporting entity.

Example 5. The method of either of examples 1 or 2, in which the QoS information includes a classification of the second communication network.

Example 6. The method of either of examples 1 or 2, in which the QoS information includes a request message indicating a requested change in a round-trip delay of the end-to-end network connection, a one-way delay of the end-to-end network connection, or a packet error rate provided to the reporting entity.

Example 7. The method of either of examples 1 or 2, in which the QoS information includes at least one of application information or traffic information.

Example 8. The method of either of examples 1 or 2, in which obtaining, by the network element, QoS information of the second communication network from the reporting entity within the second communication network includes measuring a delay between the first communication network and an endpoint server within the second communication network.

Example 9. The method of either of any of examples 1-8, in which the network element is within the second communication network, and obtaining, by the network element, QoS information of the second communication network from the reporting entity within the second communication network includes measuring a delay between the reporting entity and the network element.

Example 10. The method of either of any of examples 1-8, in which the network element is within a third communication network that is communicably connected to the second communication network through the first communication network, and obtaining, by the network element, QoS information of the second communication network from the reporting entity within the second communication network includes measuring a delay between the reporting entity and the network element.

Example 11. The method of either of any of examples 1-8, in which the network element is within the first communication network, and obtaining, by the network element, QoS information of the second communication network from the reporting entity within the second communication network includes measuring a delay between the reporting entity and the network element.

Example 12. The method of either of any of examples 1-8, in which determining, by the network element within the end-to-end network connection, the QoS requirement of the end-to-end network connection includes, determining, by the network element, a QoS requirement of the end-to-end network connection based on a service agreement, application type, or user request, and adjusting, by the network element, the QoS parameter of the first communication network based on the determined QoS requirement and the obtained QoS information includes adjusting, by the network element, a 5G QoS parameter of the first communication network.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G)as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for improving Quality of Service (QoS) in an end-to-end network connection including a first communication network and a second communication network, comprising:
determining, by a network element within the end-to-end network connection, a QoS requirement of the end-to-end network connection;
obtaining, by the network element, QoS information of the second communication network from a reporting entity within the second communication network; and
adjusting, by the network element, a QoS parameter of the first communication network based on the determined QoS requirement and the obtained QoS information.

2. The method of claim 1, wherein the first communication network is a 5G network and the second communication network is not a 5G network.

3. The method of claim 1, wherein the reporting entity is a device within the second communication network and the network element is a device within the first communication network,
the method further comprising measuring the QoS information by the reporting entity,
wherein obtaining, by the network element, QoS information of the second communication network from the reporting entity within the second communication network comprises receiving the QoS information from the reporting entity by the network element.

4. The method of claim 1, wherein the QoS information includes at least one of a round-trip delay of the end-to-end network connection, a one-way delay of the end-to-end network connection, or a packet error rate provided to the reporting entity.

5. The method of claim 1, wherein the QoS information includes a classification of the second communication network.

6. The method of claim 1, wherein the QoS information includes a request message indicating a requested change in a round-trip delay of the end-to-end network connection, a one-way delay of the end-to-end network connection, or a packet error rate provided to the reporting entity.

7. The method of claim 1, wherein the QoS information includes at least one of application information or traffic information.

8. The method of claim 1, wherein obtaining, by the network element, QoS information of the second communication network from the reporting entity within the second communication network comprises measuring a delay between the first communication network and an endpoint server within the second communication network.

9. The method of claim 1, wherein:
the network element is within the second communication network; and
obtaining, by the network element, QoS information of the second communication network from the reporting entity within the second communication network comprises measuring a delay between the reporting entity and the network element.

10. The method of claim 1, wherein:
the network element is within a third communication network that is communicably connected to the second communication network through the first communication network; and
obtaining, by the network element, QoS information of the second communication network from the reporting entity within the second communication network comprises measuring a delay between the reporting entity and the network element.

11. The method of claim 1, wherein:
the network element is within the first communication network; and
obtaining, by the network element, QoS information of the second communication network from the reporting entity within the second communication network comprises measuring a delay between the reporting entity and the network element.

12. The method of claim 1, wherein:
determining, by the network element within the end-to-end network connection, the QoS requirement of the end-to-end network connection comprises determining, by the network element, a QoS requirement of the end-to-end network connection based on a service agreement, application type, or user request; and
adjusting, by the network element, the QoS parameter of the first communication network based on the determined QoS requirement and the obtained QoS information comprises adjusting, by the network element, a 5G QoS parameter of the first communication network.

13. A network element, comprising:
a processor configured with processor-executable instructions to:
determine a QoS requirement of an end-to-end network connection including a first communication network and a second communication network;
obtain QoS information of the second communication network from a reporting entity within the second communication network; and
adjust a QoS parameter of the first communication network based on the determined QoS requirement and the obtained QoS information.

14. The network element of claim 13, wherein the first communication network is a 5G network and the second communication network is not a 5G network.

15. The network element of claim 13, wherein:
the reporting entity is a device within the second communication network and the network element is configured for use within the first communication network; and
the processor is further configured with processor-executable instructions to:
measure the QoS information by the reporting entity; and
obtain QoS information of the second communication network from the reporting entity within the second communication network by receiving the QoS information from the reporting entity by the network element.

16. The network element of claim 13, wherein the QoS information includes at least one of a round-trip delay of the end-to-end network connection, a one-way delay of the end-to-end network connection, or a packet error rate provided to the reporting entity.

17. The network element of claim 13, wherein the QoS information includes a classification of the second communication network.

18. The network element of claim 13, wherein the QoS information includes a request message indicating a requested change in a round-trip delay of the end-to-end network connection, a one-way delay of the end-to-end network connection, or a packet error rate provided to the reporting entity.

19. The network element of claim 13, wherein the QoS information includes at least one of application information or traffic information.

20. The network element of claim 13, wherein the processor is further configured with processor-executable instructions to obtain QoS information of the second communication network from the reporting entity within the second communication network by measuring a delay between the first communication network and an endpoint server within the second communication network.

21. The network element of claim 13, wherein:
the network element is within the second communication network; and
obtain QoS information of the second communication network from the reporting entity within the second communication network by measuring a delay between the reporting entity and the network element.

22. The network element of claim 13, wherein:
the network element is within a third communication network that is communicably connected to the second communication network through the first communication network; and
obtain QoS information of the second communication network from the reporting entity within the second communication network by measuring a delay between the reporting entity and the network element.

23. The network element of claim 13, wherein:
the network element is within the first communication network; and
obtain QoS information of the second communication network from the reporting entity within the second communication network by measuring a delay between the reporting entity and the network element.

24. The network element of claim 13, wherein:
determine the QoS requirement of the end-to-end network connection by determining a QoS requirement of the end-to-end network connection based on a service agreement, application type, or user request; and
adjust the QoS parameter of the first communication network based on the determined QoS requirement and the obtained QoS information by adjusting a 5G QoS parameter of the first communication network.

25. A network element, comprising:
means for determining a QoS requirement of an end-to-end network connection including a first communication network and a second communication network;
means for obtaining QoS information of the second communication network from a reporting entity within the second communication network; and
means for adjusting a QoS parameter of the first communication network based on the determined QoS requirement and the obtained QoS information.

26. The network element of claim 25, wherein the reporting entity is a device within the second communication network and the network element is a device within the first communication network,
the network element further comprising means for measuring the QoS information by the reporting entity,
wherein means for obtaining QoS information of the second communication network from the reporting entity within the second communication network comprises means for receiving the QoS information from the reporting entity by the network element.

27. The network element of claim 25, wherein:
the network element is within the second communication network; and
means for obtaining QoS information of the second communication network from the reporting entity within the second communication network comprises means for measuring a delay between the reporting entity and the network element.

28. The network element of claim 25, wherein:
the network element is within a third communication network that is communicably connected to the second communication network through the first communication network; and
means for obtaining QoS information of the second communication network from the reporting entity within the second communication network comprises means for measuring a delay between the reporting entity and the network element.

29. The network element of claim 25, wherein:
the network element is within the first communication network; and
means for obtaining QoS information of the second communication network from the reporting entity within the second communication network comprises means for measuring a delay between the reporting entity and the network element.

30. A non-transitory processor-readable medium having stored thereon processor-executable instructions configured to cause a processor of a network element to perform operations comprising:
determining a QoS requirement of an end-to-end network connection including a first communication network and a second communication network;
obtaining QoS information of the second communication network from a reporting entity within the second communication network; and
adjusting a QoS parameter of the first communication network based on the determined QoS requirement and the obtained QoS information.
